(19) United States
(12) Patent Application Publication
(10) Pub. No.: US 2008/0002135 A1
(43) Pub. Date: Jan. 3, 2008

(54) Display device and method for manufacturing the same

(76) Inventor: Young Soo Ahn, Goyang-si (KR)

Correspondence Address: MCKENNA LONG & ALDRIDGE LLP, 1900 K STREET, NW, WASHINGTON, DC, 20006, US

(21) Appl. No.: 11/647,284

(22) Filed: Dec. 29, 2006

(30) Foreign Application Priority Data
Jun. 30, 2006 (KR) 60144/2006

(51) Int. Cl. G02F 1/1339

(52) U.S. Cl. 349/155

(57) ABSTRACT

Provided are a display device and a method for manufacturing the same. The display device includes a display panel, an additional panel, and a gap maintaining member. The display panel includes a display face displaying an image and a rear face facing the display face. The additional panel faces one of the display face and the rear face in the display panel. The gap maintaining member is partially disposed between the display panel and the additional panel to maintain a gap between the display panel and the additional panel.

This application claims the benefit of Korean Patent Application No. 2006-60144, filed Jun. 30, 2006, which is hereby incorporated by reference for all purposes as if fully set forth herein.

### BACKGROUND OF THE INVENTION

1. Field of the Invention

The present invention relates to a display device and a method for manufacturing the same.

2. Discussion of the Related Art

The technical developments of an information processing device that processes a large amount of data in a short time and a display device that displays an image using the processed data in the information processing device have been made rapidly.

Users of the display device demand various additional functions such as a three-dimensional images, a dual view, a vail view, and a tough screen in addition to receiving an image from the display device. Therefore, the display device includes these various additional functions by installing a separate panel having additional functions into the display device.

However, since the separate panel is installed into the display device, there is a predetermined space between the display device and the panel. The predetermined space is exposed to air, thereby increasing the reflectivity between the display device and the panel. Consequently, the reflectivity of the display reduces.

### SUMMARY OF THE INVENTION

Accordingly, the present invention is directed to a display device and a method for manufacturing the same that substantially obviate one or more problems due to limitations and disadvantages of the related art.

An advantage of the present invention is to provide a display device preventing a transmissivity drop in a space between a display panel and an additional panel, and a method for manufacturing the same.

Another advantage of the present invention is to provide a display device capable of accurately controlling a gap between a display panel and an additional panel, and a method for manufacturing the same.

Additional advantages, features of the invention will be set forth in part in the description which follows and in part will become apparent to those having ordinary skill in the art upon examination of the following or may be learned from practice of the invention. These and other advantages of the invention may be realized and attained by the structure particularly pointed out in the written description and claims hereof as well as the appended drawings.

To achieve these advantages and in accordance with the purpose of the invention, as embodied and broadly described herein, there is provided a display device including: a display panel having a display face displaying an image and a rear face facing the display face; an additional panel facing one of the display face and the rear face in the display panel; and a gap maintaining member partially disposed between the display panel and the additional panel, wherein the gap maintaining member maintains a gap between the display panel and the additional panel.

In another aspect of the present invention, there is provided a method for manufacturing a display device, the method including: providing a display panel and an additional panel; forming a gap maintaining member having a predetermined height on one of the display panel and the additional panel; and mutually attaching the display panel and the additional panel, wherein the gap maintaining member is disposed between the display panel and the additional panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A and 1B are sectional views of a display device according to a first embodiment of the present invention;

FIGS. 2A to 2C are plan views illustrating arrangement positions of a gap maintaining member according to an embodiment of the present invention;

FIGS. 3A to 3C are sectional views of a gap maintaining member according to an embodiment of the present invention;

FIGS. 4A to 4D are sectional views illustrating a method for manufacturing a display device according to a second embodiment of the present invention; and

FIGS. 5A to 5B are sectional views illustrating a method for manufacturing according to a third embodiment of the present invention.

### DETAILED DESCRIPTION OF THE ILLUSTRATED EMBODIMENTS

Reference will now be made in detail to the preferred embodiments of the present invention, examples of which are illustrated in the accompanying drawings.

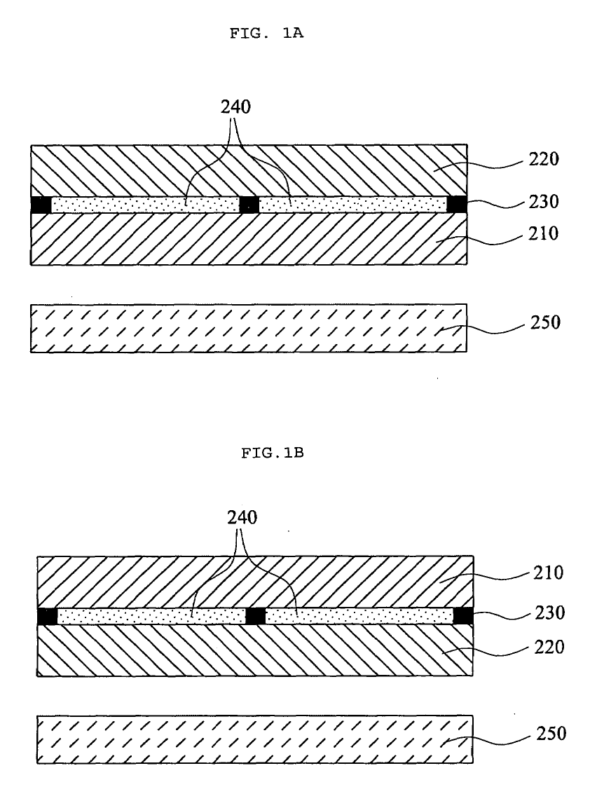

FIGS. 1A and 1B are sectional views of a display device according to a first embodiment of the present invention.

Referring to FIGS. 1A and 1B, the display device includes a display panel 210, an additional panel 220, and a gap maintaining member 230.

The display panel 210 provides a user with an image. The display panel 210 may include a liquid crystal panel, an organic light emitting diode panel, a field emitter display panel, and a plasma display panel, etc.

When the display panel 210 includes a liquid crystal panel providing an image by external light, the display device may include a light source unit 250 providing light for the display panel 210. As illustrated in FIG. 1A, the light source unit 250 may be disposed on a rear face facing the display face of the display panel 210. Alternatively, as illustrated in FIG. 1B, the light source unit 250 may be disposed on an additional panel 220 that will be discussed later. In this embodiment, the light source unit 250 provides light to the additional panel 220, and the light passes through the additional panel 220, to the display panel 210.

The additional panel 220 may be disposed on the display panel 210 to provide additional functions to the display device. For example, the additional panel 220 may be a barrier panel for a three-dimensional image, a touch panel for a touch screen, a vail panel for information security using one directional viewing angle, and an additional display panel for a dual view.

The gap maintaining member 230 may be interposed between the display panel 210 and the additional panel 220, thereby uniformly maintaining a gap between the display panel 210 and the additional panel 220. The gap maintaining member 230 may have a substantially column shape, and the number of the gap maintaining member 230 is at least two. In this embodiment, the gap maintaining members 230 substantially have the same height measured from an upper face of the display panel 210.

The gap between the display panel 210 and the additional panel 220 is determined by the height of the gap maintaining member 230.

The additional panel 220 embodies functions such as a three-dimensional image view, a dual view, and a vail view by using a selective screening function of light parallax. In this embodiment, the gap maintaining member 230 adjusts the light parallax of the additional panel 220 by accurately controlling the thickness between the display panel 210 and the additional panel 220.

In this embodiment, the gap maintaining member 230 may include a material having elasticity for easing or absorbing an external impact. Examples of a material that may be used as the gap maintaining member 230 include an acrylic-based compound, a vinyl-based compound, a urethane-based compound, and a silicon-based compound, etc.

In order to attach the additional panel 220 to the display panel 210, an adhesive member 240 may be interposed between the display panel 210 and the additional panel 220.

The adhesive member 240 may include a curable resin filled in the gap between the display panel 210 and the additional panel 220 except for a region on which the gap maintaining member 230 is disposed. The curable resin may be a thermosetting resin or a light curable resin.

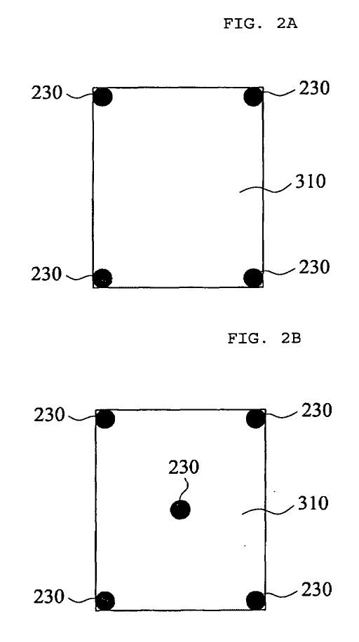

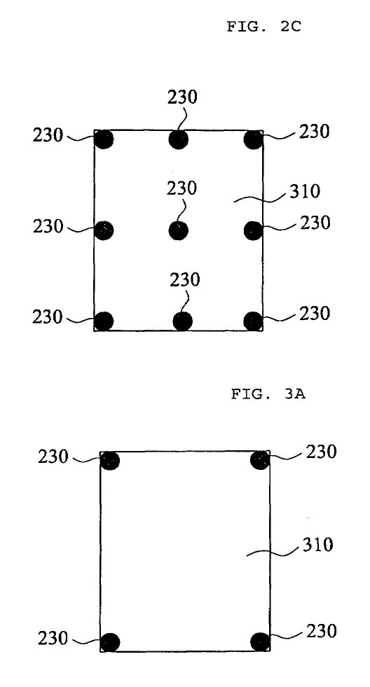

FIGS. 2A to 2C are plan views illustrating arrangement positions of a gap maintaining member according to an embodiment of the present invention.

Referring to FIGS. 2A to 2C, the gap maintaining member 230 is disposed on one panel 310 of the display panel and/or the additional panel illustrated in FIGS. 1A and 1B.

In this embodiment, the gap maintaining member 230 may be arranged on four corner portions of the panel 310 as illustrated in FIG. 2A.

As illustrated in FIG. 2B, the gap maintaining member 230 may be arranged on four corner portions of the panel 310 and a center portion of the panel 310.

As illustrated in FIG. 2C, the gap maintaining members 230 may be arranged on four corner portions of the panel 310, the center portion of the panel 310, and the middle portions of the two edges opposite to each other.

FIGS. 3A to 3C are sectional views of a gap maintaining member according to an embodiment of the present invention.

Referring to FIGS. 3A to 3C, the gap maintaining member 230 may have a various shapes. As illustrated in FIG. 3A, the gap maintaining member 230 may have a substantially circular shape in a plan view. Alternatively, as illustrated in FIG. 3B, the gap maintaining member 230 may have a substantially rectangular shape in a plan view. As illustrated in FIG. 3C, the gap maintaining member 230 may have a substantially diamond shape in a plan view.

In this embodiment, the present invention is not limited to the positions of the gap maintaining member 230, the shapes of the gap maintaining member 230, and the number of the gap maintaining members 230.

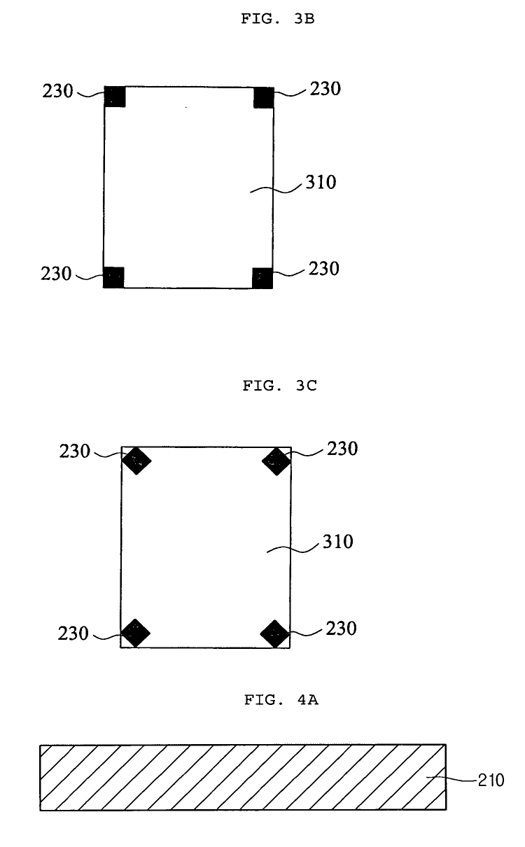

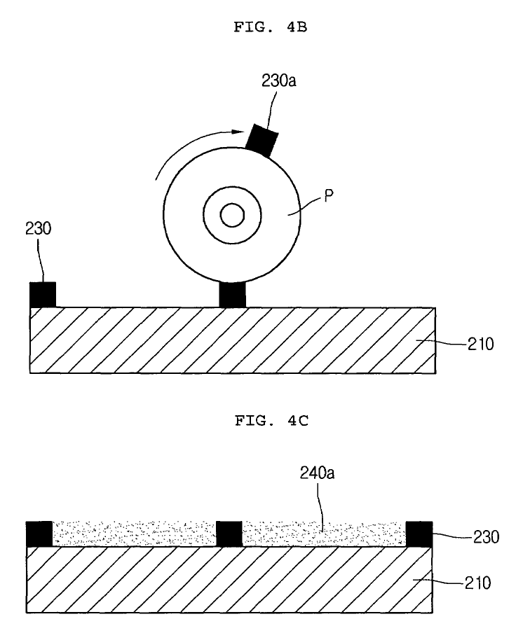

FIGS. 4A to 4D are sectional views illustrating a method for manufacturing a display device according to a second embodiment of the present invention.

In FIG. 4A, a display panel 210 that displays an image is provided. The display panel 210 may include a liquid crystal panel, an organic light emitting diode panel, a field emitter display panel, and a plasma display panel, etc.

The display panel 210 includes a display face that displays the image and a rear face facing the display face.

In FIG. 4B, the gap maintaining member 230 is formed on the rear face of the display panel 210.

The gap maintaining members 230 may be arranged on at least two corner portions of the display panel 210. The gap maintaining member 230 may be in one of a substantially round shape, a substantially rectangular shape, and a substantially diamond shape in a plan view.

Here, the gap maintaining member 230 may be formed using a printing method. More specifically, a printing plate P having a preliminary gap maintaining member 230a is aligned on the display panel 210 to form the gap maintaining member 230. The preliminary gap maintaining member 230a of the printing plate P is transferred to form the gap maintaining member 230 on the display panel 210.

In FIG. 4C, after forming the gap maintaining member 230, a solution 240a is applied to form an adhesive member on one side of the display panel 210 having the gap maintaining member 230. The solution 240a includes a curable resin that can be a thermosetting resin cured by heat or a light curable resin cured by light. According to this embodiment, the light curable resin is cured by ultraviolet rays.

In FIG. 4D, after the curable resin is applied to form the adhesive member 240 on the display panel 210, an additional panel 220 is attached to the display panel 210 by pressing. Here, when the display panel 210 and the additional panel 220 are attached, the solution does not overflow. This is why the solution 240a applied according to the height of the gap maintaining member 230 can be accurately calculated.

The additional panel 220 may be a barrier panel, a touch panel, a vail panel, and an additional display panel.

Next, the curable resin 240a is cured to form an adhesive member 240 interposed between the display panel 210 and the additional panel 220, and then the adhesive member 240 is formed to completely attach the additional panel 220 to the display panel 210.

In this embodiment, the curing process for forming the adhesive member 240 applies a heat to the solution 240a for a heat cure or projects an ultraviolet ray into the solution 240a for a light cure.

Furthermore, when the display panel 210 may be a liquid crystal panel, a light source unit, for example, 250 of FIG. 1A, is disposed on one of the display panel 210 and the additional panel 220. In this embodiment, the light source unit 250 can be attached to the display panel 210 as illustrated in FIG. 1A, or the light source unit 250 can be attached to the additional panel 220 as illustrated in FIG. 1B.

According to the embodiment, the present invention is not limited to the formation of the gap maintaining member 230 on the display panel 210. That is, after the gap maintaining member 230 is formed on the additional panel 230, a curable resin is applied to the additional panel 230. Next, the display panel 210 is aligned on the additional panel 230, and then the display device is manufactured through a curing process.

As described above, the gap maintaining member 230 is formed between the display panel 210 and the additional panel 220, and a curable resin is filled between the display panel 210 and the additional panel 220 by considering the height of the gap maintaining member 230, thereby preventing the overflow of the curable resin that occurs due to the attachment press. Accordingly, an additional cleaning process is unnecessary. Thus, a manufacturing cost of the display device is reduced.

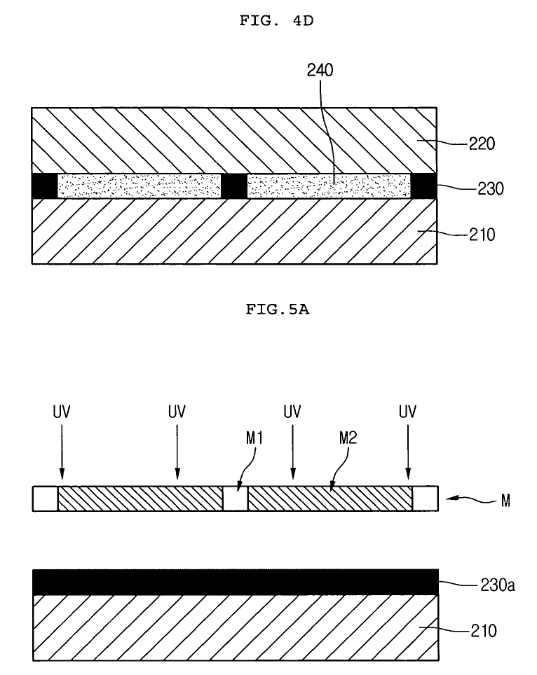

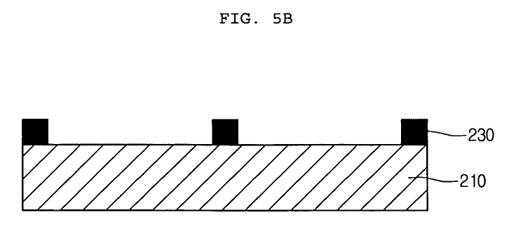

FIGS. 5A to 5B are sectional views illustrating a method for manufacturing a display device according to a third embodiment of the present invention.

The manufacturing processes, except that for the gap maintaining member, use an exposure method identical to those in the second embodiment. Accordingly, wherever possible, the same reference numbers will be used throughout the drawings to refer to the same or like parts, and the repeated description will be omitted for simplicity.

In FIG. 5A, the display panel 210 is provided to manufacture a display device. A photosensitivity resin is applied to the display panel 210 to form a photosensitive film 230a on the display panel 210.

Next, a mask M having a light transmitting part M1 and a light screening part M2 is aligned on the photosensitive film 230a. Next, light is provided on the mask M, and the photosensitive film 230a that corresponds to the light transmitting part M1 is exposed to the light.

In FIG. 5B, an exposure process is performed on the photosensitive film 230a, and then the photosensitive film 230a is developed by a developing solution to form the gap maintaining member 230 on the display panel 210.

In the display device and the method for manufacturing the same of the present invention, the gap maintaining member is formed between the display panel and the additional panel, thereby accurately controlling a gap between the display panel and the additional panel. The accurate controlling of the space between the display panel and the additional panel prevents a viewing angle defect from occurring.

Additionally, the interval deviation between the display panel and the additional panel can be minimized by forming the gap maintaining member between the display panel and the additional panel.

Moreover, an amount of a curable resin can be calculated and applied based on the height of the gap maintaining member by forming the gap maintaining member between the display panel and the additional panel. Therefore, overflow due to the attachment pressure does not occur, and a cleaning process for the curable resin becomes unnecessary.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a display panel having a display face displaying an image and a rear face facing the display face;
an additional panel facing one of the display face and the rear face of the display panel; and
a gap maintaining member partially disposed between the display panel and the additional panel, wherein the gap maintaining member maintains a gap between the display panel and the additional panel.

2. The display device according to claim 1, wherein the gap maintaining member is disposed on at least two corner portions of the display panel and the additional panel.

3. The display device according to claim 1, wherein the gap maintaining member has a substantially column shape.

4. The display device according to claim 1, wherein the gap maintaining member has one of a substantially round shape, a substantially rectangular shape, and a substantially diamond shape.

5. The display device according to claim 1, further comprising an adhesive member interposed between the display panel and the additional panel to attach the display panel and the additional panel.

6. The display device according to claim 5, wherein the adhesive member comprises a curable resin.

7. The display device according to claim 6, wherein the curable resin comprises one of a thermosetting resin and a light curable resin.

8. The display device according to claim 1, further comprising a light source unit disposed on the rear surface facing the display surface to provide light to the display panel.

9. The display device according to claim 1, wherein the additional panel comprises a light source unit providing light to the display panel.

10. A method for manufacturing a display device, the method comprising:
providing a display panel and an additional panel;
forming a gap maintaining member having a predetermined height on one of the display panel and the additional panel; and
mutually attaching the display panel and the additional panel, wherein the gap maintaining member is disposed between the display panel and the additional panel.

11. The method according to claim 10, wherein the forming of the gap maintaining member comprises:
providing a printing plate having a preliminary gap maintaining member; and
transferring the preliminary gap maintaining member on one of the display panel and the additional panel to form the gap maintaining member on one of the display panel and the additional panel.

12. The method according to claim 10, wherein the forming of the gap maintaining member comprises:
forming a photosensitive film on one of the display panel and the additional panel; and
exposing and developing the photosensitive film to form the gap maintaining member on one of the display panel and the additional panel.

13. The method according to claim 10, wherein the mutual attaching of the display panel and the additional panel comprises: forming an adhesive member between the display panel and the additional panel to attach the display panel and the additional panel.

14. The method according to claim 13, wherein the forming of the adhesive member comprises:
coating one surface of the panel having the gap maintaining member with a curable resin to form the adhesive member; and
curing the curable resin.

15. The method according to claim 14, wherein the curing of the curable resin comprises heating the curable resin.

16. The method according to claim 14, wherein the curing of the curable resin comprises providing light on the curable resin.
